(19) United States
(12) Patent Application Publication
(10) Pub. No.: US 2017/0032339 A1
(43) Pub. Date: Feb. 2, 2017

(54) Comprehensive Ecosystem for Providing All the Needs and/or Services of Tenants, Management and Landlords in a Residential Community

(71) Applicant: Hadar Goldman, Savyon (IL)

(72) Inventor: Hadar Goldman, Savyon (IL)

(21) Appl. No.: 15/223,325

(22) Filed: Jul. 29, 2016

Related U.S. Application Data
(60) Provisional application No. 62/198,744, filed on Jul. 30, 2015.

(51) Int. Cl. G06Q 20/10; G06F 3/048

(52) U.S. Cl. CPC G06Q 20/102; G06F 3/048; G06Q 50/01

(57) ABSTRACT

The present invention generally relates to new and improved methods and systems, and more broadly relates to an entirely new and comprehensive ecosystem, for providing all of the possible needs and/or services of tenants, management and landlords in a residential community. This includes, just for example, but is not limited to, a digital, preferably mobile platform based ecosystem for meeting most of their social needs and financial needs and/or services; for instance, where all payments of bills can be made, all types of orders can be placed online, where all social networking can take place to meet their social needs, where all services for tenants are provided, and where every other type of need will be met for tenants, management and landlords.

### CROSS-REFERENCE TO RELATED APPLICATION

This non-provisional application claims benefit of the provisional application U.S. Ser. No. 62/198,744 filed on Jul. 30, 2015.

### FEDERAL FUNDING LEGEND

This invention was not created using federal funds.

### BACKGROUND OF THE INVENTION

Field of the Invention

The present invention generally relates to new and improved methods and systems to address all of the possible needs and/or services of tenants, management and landlords in a residential community. More specifically, the present invention provides a digital, preferably a mobile platform based comprehensive ecosystem that meets all the social and financial needs and/or services of the tenants, management and landlords in a residential community.

Background

With a consistently increasing population year after year, there is a general trend towards more densely populated towns, cities, and very large urban and metropolitan centers. With more dense populations, the residential real estate market has become an increasingly highly competitive industry. Many residents simply choose to sign a lease and pay rent to a landlord, rather than purchase their own property. These residents, or tenants of a rental property, often have many choices regarding where they can rent, Location, rental price, and access to amenities are often some of the most compelling and important reasons in deciding where to sign a lease and choosing a particular rental property. Since there are often so many choices regarding different rental properties, this puts a great deal of pressure on rental management companies to compete for prospective tenants. Unfortunately, despite the growing demand by prospective tenants for finding the ideal rental property, residential management companies often fail to meet all the demands and desires of their prospective tenants. Current tenants of residential properties are also frequently frustrated with residential management companies, and vice versa. In fact, disputes often arise between landlords and tenants, which often leads to grievances, eviction, legal problems, and other unfortunate consequences for both tenants and landlords. Basically, there has always been a failure of residential management companies to deliver all of the wide array of possible services and amenities that their tenants desire, despite increasing demands by tenants for access to a wide range of convenient services.

Currently, technology exists that can be used only by the residential management because the technology supports the needs of the management or landlords as it is used to record expenses, income and so on. Residential management companies have failed to provide comprehensive online services for their tenants, including for example a convenient, secure online system that aggregates and delivers information about vendor services for tenant usage. There is a long-felt but unmet need for systems and methods for aggregation and delivery of information and services for the residential real estate industry.

### SUMMARY OF EMBODIMENTS OF THE INVENTION

In a preferred embodiment, the present invention is directed to a digital platform based ecosystem to address the needs of a residential community, comprising: means to search for or locate an amenity, a service, or both; means to pay for the amenity, service or both; means to allow social networking; means to pay bills, place orders or both; means to co-ordinate services with vendors; means to store contacts, names of vendors, pricing information about products and services, service providers, residential property management information and other resources; means to request repairs of a rental unit, repairs of a defective appliance, replacement of a defective appliance, delivery of food, delivery of grocery, delivery of package, delivery of a gift or similar item; means to post information, share information, receive responses, or a combination thereof within the residential community; means to communicate by voice, pictures, audio, writing or a combination thereof within the residential community; or a combination thereof.

In another embodiment, the digital platform further comprises means to aggregate and offer all the information pertaining to the vendor and the services provided by the vendor, thereby updating the information and services that is available to the residential community.

In yet another embodiment, the information pertaining to the vendor and the services provided by the vendor can be accessed anytime and anywhere.

In still yet another embodiment, the amenity or the service meets the social need, financial need or both of the residential community.

In further yet another embodiment, the amenity or the service includes but is not limited to a restaurant, an entertainment avenue, tickets for the entertainment avenue, a movie theater, ticket for the movie theater, a nightclub, a grocery store, a laundromat, an automotive service, an exercise gym, a sports facility, a clothing store, a general retail store, a specialty retail store, a loan service, a legal service, healthcare service, utility service, cleaning service, insurance service, car sales, leasing service, service pertaining to child care, service pertaining to pets or a combination thereof.

In yet another embodiment, vendors include but is not limited to furniture companies, providers of accessories for residential tenants, lawn maintenance companies, pool services, or any other vendor that provides services to the residential community.

In yet another embodiment, the digital platform includes but is not limited to a web-based application, a mobile application, a virtual reality application or a combination thereof.

In still yet another embodiment, the digital platform is implemented using a combination of hardware and software systems, computer systems, network or networks of computers, cloud-computing systems, or other systems or networks that allow for aggregation and delivery of information.

In yet another embodiment, the digital platform is accessed on electronic device comprising Apple-brand iPhone, Apple-brand iPad, Apple-brand tablet, or Android-brand device.

In yet another embodiment, the digital platform is a mobile app that uses HTML5, virtual reality or augmented reality.

### BRIEF DESCRIPTION OF THE DRAWINGS

FIG. 1 shows schematic representation of a preferred embodiment of the present invention.

### DETAILED DESCRIPTION

The present application very broadly encompasses new and improved methods and systems, and more broadly relates to an entirely new and comprehensive ecosystem, for providing all of the possible needs and/or services of tenants, management and landlords in a residential community. This includes, just for example, but is not limited to, a digital, preferably mobile, platform based ecosystem for meeting most of their social needs and financial needs and/or services; for instance, where all payments of bills can be made, all types of orders can be placed online, where all social networking can take place to meet their social needs, where all services for tenants are provided, and where every other type of need will be met for tenants, management and landlords. The comprehensive ecosystem also provides, by way of example, but is not limited to providing, the aggregation and delivery of all possible types of services and information for a residential community.

According to a preferred embodiment, the new and comprehensive ecosystem of the present invention, for providing all of the possible needs and/or services of tenants, management and landlords in a residential community, comprises a total digital platform that can be used by tenants, residential facility management and landlords; and preferably includes web (Internet), mobile applications and augmented and virtual reality as means of its usage. This digital platform enables tenants to reliably, easily and efficiently locate any number of desired services and amenities, for instance, through one or more different mobile applications. The digital platform functions as a comprehensive platform between tenants and vendors of the services and amenities.

According to a preferred embodiment, using the new and comprehensive ecosystem of the present invention, which comprises the total digital platform of the present invention, a tenant can search for and find any type of desired service or amenity including, but not limited to, restaurants, entertainment venues and tickets, movie theaters, nightclubs, employment-related services, grocery stores, laundromats, automotive services, exercise gyms, sports facilities, clothing stores, general and specialty retail stores, loan services, legal services, healthcare services, and any other possible type of service or amenity. Other services for tenants that are accessible via the digital platform include any type of utility service, for instance, electricity, gas, water, and other utilities. Using the comprehensive ecosystem of the present invention, tenants can also access any other type of service via the digital platform, for instance, cleaning services, insurance services, car sales, leasing services, child services, etc.

Tenants can also get discounts on services and become eligible for preferred rewards and other incentive programs using the digital platform. Tenants can also order and pay for services, conveniences, benefits, and amenities electronically, for instance, using a mobile phone, other mobile handheld device, computer, or other device. All services and offerings will preferably be joined under one connected digital platform.

According to another preferred embodiment, the comprehensive ecosystem, which comprises the total digital platform of the present invention, also functions as a social network between tenants. The comprehensive ecosystem of the present invention is thus effective for meeting the social needs of the tenants. Thus, according to one example, a tenant can use the digital platform to locate other tenants, new friends and colleagues, and find social events in any desired geographic location. The ecosystem thus provides a platform where all social networking can take place to meet their social needs, including for instance providing an updated calendar of social events, and where all other social services for tenants are provided.

According to yet another preferred embodiment, the ecosystem of the present invention is also effective for providing the financial needs and/or services for tenants, management and landlords within a residential community. For instance, the ecosystem provides a platform where all payments of bills can be made, all types of orders can be placed online, and where other financial or accounting-related services for tenants, management and landlords are provided.

Other representative services provided via the ecosystem of the present invention include, for instance, but are not limited to, coordinating services with furniture companies and providers of accessories for residential tenants, lawn maintenance companies, pool services for a residential community, and coordinating activities with any other type of business vendor that provides services to a residential community.

The ecosystem of the present invention, which comprises the digital platform, can comprise a database of information including a database of contacts, names of vendors, pricing to information about products and services, service providers, residential property management information, and other resources. The digital platform can also be customized as needed or desired by the users. For instance, the digital platform can have an interactive display for the users, and this display can comprise one or more audio, visual and/or other features.

The total digital platform of the present invention is also preferably accessible twenty-four hours a day, seven days a week for tenants, residential facility management and landlords. The digital platform thus allows tenants to communicate on a regular basis other people, including for example other tenants, as well as landlords and property managers.

According to yet another preferred embodiment, the present invention provides a very efficient system for aggregating and using all the latest available information about vendor services for tenants, and also aggregating other types of information including the latest online information about residential properties. As new vendors start offering services in the marketplace, the digital platform can automatically aggregate and offer all this information and services and thus dynamically updates the information and services that is made available to users. Preferably, the services provided by the vendors can be accessed anytime and anywhere, since the services will be accessible via a virtual system, for instance, accessible via cloud-computing.

Residential facility management and landlords can also use the ecosystem of the present invention, which comprises the digital platform, to post and share information that is useful to tenants, for example, information about variations in rental prices, different options for paying rent (e.g. electronic payment options), contact information for property managers, after-hours contact information, and other types of useful information, for a residential community. Users of the digital platform can also submit requests online, for example, requests for repairs of a rental in unit, repair or replacement of a defective appliance, as well as any other type of request, such as a request for delivery of food (e.g. pizza delivery), grocery delivery, package delivery, or delivery of a gift or other item. Users of the digital platform can also have interactive communication and dialogue, as well as receive answers from vendors, shop online, and communicate via voice, pictures, audio, writing, or any combination of any one or more modes of communication.

One of the additional primary advantages, benefits and purposes of the present invention is to create value for the owners and management companies, all over the world, decreasing turn-over of the tenants, solving problems of the tenants via the use of mobile applications, and offering a wide range of various consumer services and products, and other types of services and products, to tenants via a wide variety of vendors.

According to certain preferred embodiments, the present invention offers a comprehensive online ecosystem and digital platform for tenants which functions as a one-stop shop for various goods and services. The present invention thus effectively provides a new method of doing business that represents a new ecosystem that provides for interaction and exchange of information between tenants, landlords, vendors, service providers, and other members of a residential real estate community.

The online system and digital platform of the present invention can be designed and implemented using any suitable combination of hardware and software systems, computer system(s), network or networks of computers, cloud-computing system(s), and/or any other system(s) or network(s) that allows for the aggregation and delivery of information, communication, and other features described herein of the present invention. The online system and digital platform of the present invention can preferably operate as a virtual system.

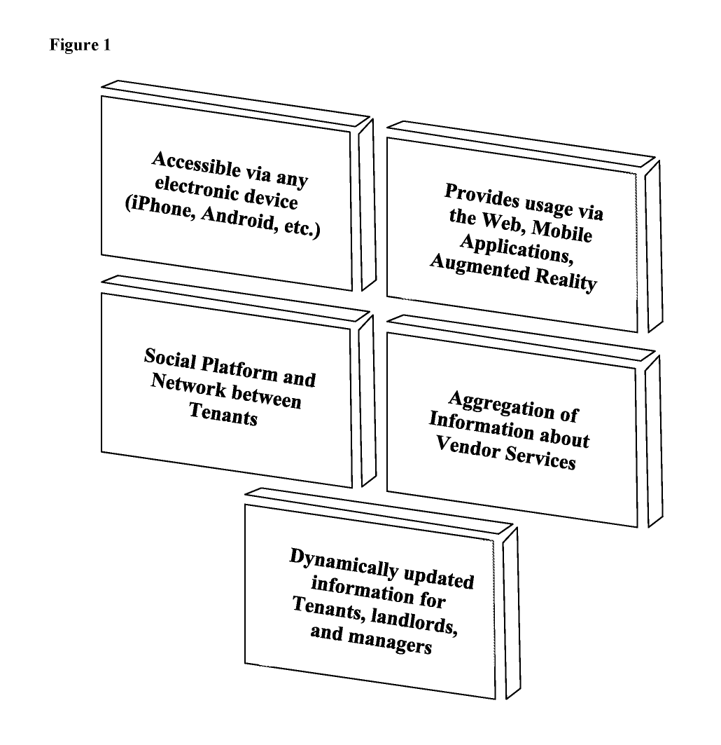

FIG. 1 is a schematic representation of a preferred embodiment of the total digital platform of the present invention. As depicted schematically in FIG. 1, the total digital platform can be used by tenants, residential facility management and landlords, and preferably includes web (Internet), mobile applications and virtual reality as means of its usage. The total digital platform provides dynamically updated information, and also functions as a social platform and network between tenants. Moreover, the digital platform is accessible via any type of electronic device (for example, iPhone, Android, etc). FIG. 1 is only for illustrative purposes, and is only one representative configuration that shows different representative components of the digital platform of the present invention. In addition to augmented reality, languages such as HTML5, virtual reality can also be used.

The online system and digital platform of the present invention can also be accessed via any type of electronic device including, for instance, but not limited to, any type of computer, Apple-brand iPhone, Apple-brand iPads and tablets, Android-brand devices, and any other type of electronic device. The present invention is also the only mobile app that uses languages such as HTML5, virtual reality and augmented reality.

According to yet another preferred embodiment, the present invention provides a card like a credit card, which will have a chip that connects to GPS. Tenants can use this at any time, particularly when the tenants are busy and on the move, to inform them of the nearest store, restaurant, gym, or other service, and any sales or discounts provided by these facilities.

The foregoing descriptions of the embodiments of the present invention have been presented for purposes of illustration and description. They are not intended to be exhaustive or to limit the scope of the present invention in any way. The exemplary embodiments were chosen and described in order to illustrate the principles of the present invention and its practical application, and to enable others skilled in the art to utilize the present invention.

What is claimed is:

1. A digital platform based ecosystem to address the needs of a residential community, comprising:
means to search for or locate an amenity, a service, or both;
means to pay for the amenity, service or both;
means to allow social networking;
means to pay bills, place orders or both;
means to co-ordinate services with vendors;
means to store contacts, names of vendors, pricing information about products and services, service providers, residential property management information and other resources;
means to request repairs of a rental unit, repairs of a defective appliance, replacement of a defective appliance, delivery of food, delivery of grocery, delivery of package, delivery of a gift or similar item;
means to post information, share information, receive responses, or a combination thereof within the residential community;
means to communicate by voice, pictures, audio, writing or a combination thereof within the residential community;
or a combination thereof.

2. The digital platform of claim 1, further comprising:
means to aggregate and offer all the information pertaining to the vendor and the services provided by the vendor, thereby updating the information and services that is available to the residential community.

3. The digital platform of claim 1, wherein the information pertaining to the vendor and the services provided by the vendor can be accessed anytime and anywhere.

4. The digital platform of claim 1, wherein the amenity or the service meets the social need, financial need or both of the residential community.

5. The digital platform of claim 1, wherein the amenity or the service comprises a restaurant, an entertainment avenue, tickets for the entertainment avenue, a movie theater, ticket for the movie theater, a nightclub, a grocery store, a laundromat, an automotive service, an exercise gym, a sports facility, a clothing store, a general retail store, a specialty retail store, a loan service, a legal service, healthcare service, utility service, cleaning service, insurance service, car sales, leasing service, service pertaining to child care, service pertaining to pets or a combination thereof.

6. The digital platform of claim 1, wherein the vendors comprise furniture companies, providers of accessories for residential tenants, lawn maintenance companies, pool services, or any other vendor that provides services to the residential community.

7. The digital platform of claim 1, wherein the digital platform comprises a web-based application, a mobile application, a virtual reality application or a combination thereof.

8. The digital platform of claim 1, wherein said digital platform is implemented using a combination of hardware and software systems, computer systems, network or networks of computers, cloud-computing systems, or other systems or networks that allow for aggregation and delivery of information.

9. The digital platform of claim 1, wherein said digital platform is accessed on electronic device comprising Apple-brand iPhone, Apple-brand iPad, Apple-brand, tablet, or an Android-brand device.

10. The digital platform of claim 1, wherein said digital platform is a mobile app that uses virtual reality or augmented reality.
